(19) United States
(12) Patent Application Publication
(10) Pub. No.: US 2014/0046747 A1
(43) Pub. Date: Feb. 13, 2014

(54) SYSTEM AND METHOD FOR REBATE CALCULATION

(71) Applicant: COHESION, INC. D/B/A HAWKEYE, (US)

(72) Inventors: Vaughn Aust, Kent, WA (US); Michael Fredrickson, Kent, WA (US); Richard Beanland, Kent, WA (US); Steve Murphy, Renton, WA (US)

(73) Assignee: COHESION, INC. D/B/A HAWKEYE, Kent, WA (US)

(21) Appl. No.: 13/758,202

(22) Filed: Feb. 4, 2013

Related U.S. Application Data
(63) Continuation-in-part of application No. 12/796,264, filed on Jun. 8, 2010, now abandoned.
(60) Provisional application No. 61/185,414, filed on Jun. 9, 2009.

(51) Int. Cl. G06Q 30/02

(52) U.S. Cl. CPC G06Q 30/0234
USPC 705/14.34

(57) ABSTRACT

The present invention provides a method and apparatus for rebate calculation relating to a partner incentive program. The method and system includes electronically defining the incentive program within a computer processing system and defining one or more tracks within the program. The method and system further includes electronically selecting one or more incentives within the one or more tracks and generating a plurality of incentive data defining a plurality of incentive scenarios based on the one or more incentives. The method and system includes loading the incentive data to a spreadsheet application, wherein the spreadsheet application includes a computational algorithm and performing at least one scenario calculation on the incentive data using the computational algorithm, including generating incentive rebate data. Whereby, the method and system is operative to generate a visual output display quantifying the incentive rebate data.

### RELATED APPLICATIONS

The present invention is a continuation-in-part and claims priority to U.S. patent application Ser. No. 12/796,264 entitled “MULTI-VENDOR REGISTRATION AND REWARDS SYSTEM” filed Jun. 8, 2010, which claims priority to U.S. Patent Application Ser. No. 61/185,414 filed Jun. 9, 2009.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to management systems for vendor and customer support and more specifically to management of partner marketing efforts, capturing partnership investment return and calculating a rebate for channel participants.

### BACKGROUND OF THE INVENTION

Current business practices for indirect selling channel management include Partner Relationship Management (PRM) systems that are designed to fill the needs of vendor companies to collect, distribute and analyze information from their independent channel resellers and agents in order to better manage their overall customer portfolios. Within each of these proprietary channel partner ecosystems are many forms and tools designed to educate, support and reward the performance of the independent partners who successfully register customer opportunities and sell each vendor's products and services. Meanwhile, the independent partners provide value-added services for their customer from technical consulting, to installation and training to break/fix and Tier 1 and 2 customer support, including re-selling (or acting as the agent) products and services from many vendors.

Many types of organizations want to track activity against goals for the purpose of rewarding various types of behavior. The current techniques for rebate calculations are complex and difficult to model and analyze.

There are known estimating techniques for estimating projections, such as sales projections or marketing return projections. There are also existing software applications, spreadsheet applications, allowing for columnar data to be processed in one or more projections using existing system based algorithms. These software applications have record size limitations and are limited by what types of algorithms can be employed. Similarly, for performing complex modeling operations, the upper computational threshold of these existing software applications can be readily eclipsed, thus prohibiting the ability for performing accurate and complex forecasting.

Existing forecasting systems, including systems forecasting rebate estimates for partners, are functionally limited to the existing software application having built-in projection modeling algorithms. Similarly, these systems are limited to the ability of data to be received and processed, where the received data is typically summarily and manually entered into the spreadsheet software.

Thus, existing systems suffer from not only the data entry techniques for getting possible relationship data and scenarios into the software, but also the ability to process and generate scenario data. As such, there exists a need for improved forecasting techniques and processing systems, including the computation of rebate data.

### SUMMARY OF THE INVENTION

The present invention provides for a method and system performing rebate calculations. Within the rebate calculation system, a user may define an incentive program, as well as related parameters. Based on these parameters to the program, the user may therein generate scenario calculations using a spreadsheet application.

The present method and system includes electronically defining the incentive program with a computer processing system. This may be performed using a software interface, including interface functionality within the multi-vendor registration and reward system. A next step is electronically defining one or tracks within the program. The one or more tracks provide for subsets of the incentive programs allowing for various iterations or instantiations of the incentive program.

A next step is electronically selecting one or more incentives within the one or more tracks. Incentives may be any suitable type of incentive for a customer, supplier or third party, including for example, but not limited to, cash, credit, prizes, etc.

Within the computer processing system and methodology, a next step is loading the incentive data to a spreadsheet application, wherein the spreadsheet application includes a computational algorithm. The spreadsheet application includes the interface functionality of columnar display of data fields, including the incentive reward participants, as well as the tracks and incentives within the tracks. The computational algorithm includes functionality allowing the user to perform one or more calculations on the columnar data, including running computational algorithms for viewing projected scenario and resultant data.

Therein, the method and system includes performing at least one scenario calculation on the incentive data using the computational algorithm, including generating incentive rebate data. The incentive rebate data includes information on the various types and amounts of rebates. Based on this incentive rebate data, the method and system includes the generation of a visual output display that quantifies the data. Therein, the user can visualize the incentive program based on the computational algorithm.

These and further advances and improvements provided by the system and method for rebate calculation are described below.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a flowchart diagram illustrating a functional overview of one embodiment of a partner reward system;

FIG. 2 illustrates a high-level system diagram of one embodiment of a partner reward system;

FIG. 3 illustrates a flowchart diagram of one embodiment of a reward lifecycle within the partner reward system;

FIG. 4 illustrates a block diagram illustrating aspects of embodiments of acquiring and assigning collaboration currency;

FIG. 5 illustrates a diagram of one embodiment of the rebate calculation engine;

FIG. 6 illustrates a flowchart of one embodiment of the steps of a method for rebate calculation;

FIG. 7 is a diagram of one embodiment of the calculation process for the rebate engine;

FIG. 8 illustrates a sample screen shot of a scenario manager;

FIG. 9 illustrates a sample screen shot of a column selection within a scenario manager;

FIG. 10 is a sample screen shot of column rebate calculator; and

FIG. 11 is a sample dashboard screenshot.

### DETAILED DESCRIPTION

In the following description, reference is made to the accompanying drawings that form a part hereof, and in which is shown by way of illustration specific embodiments in which the invention may be implemented. It is to be understood that other embodiments may be utilized and design changes may be made without departing from the scope of the present invention.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

The following preferred embodiments may be described in the context of a network-based system using host servers and client devices, such as the Internet, and may be adapted to various devices and communication networks without departing from the overall scope of the invention.

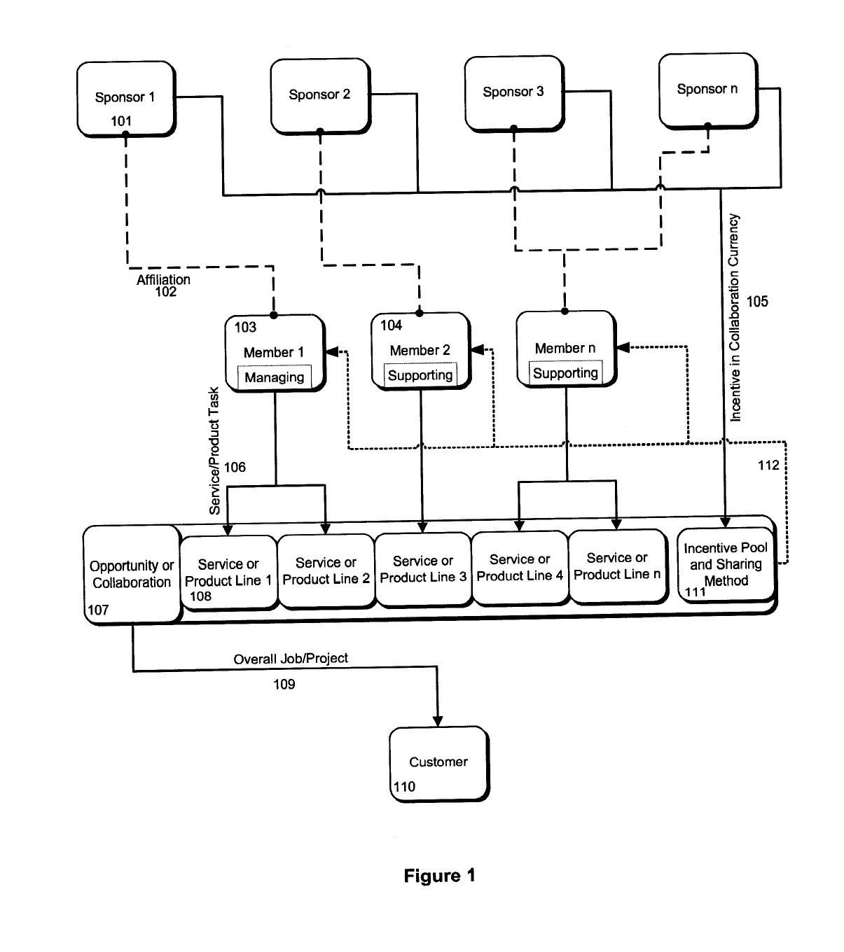

As shown in FIG. 1, embodiments of the invention may be applicable to business relationships between various entities including, for example, Sponsor (vendor) companies 101. The Sponsors 1-n 101 may be in communication over a network, such as the Internet, and may be linked to participating Members 1-n 103, 104. Members 103, 104 may be in further communication with various customers 110.

Sponsors 101 may include vendors or manufacturers organizations providing products or services through a distribution and fulfillment channel. Through the system Sponsors 101 may provide rewards or incentives when their products and services are sold through the channel.

Partner or reseller organizations of Sponsors 101 may include Members 103 who may be affiliated 102 to their respective Sponsors 101, such as by participating in partner programs, that may include obtaining vendor specific competencies, and the like.

Members 103, 104 serve their Customers 110 by providing solutions to their technology challenges and fulfill their needs with Products and/or Services 106 offerings.

When customer needs or Opportunities 107 extend beyond what a single member, e.g. Member 103, can provide, the system may allow a participant, such as Member 103, to search for, solicit support from and/or partner with other Members 104 to fill out the missing offerings and create a joint value proposition for the opportunity.

When an opportunity 107 is brought in to the network, the Member who owns the customer relationship is defined as the Managing Partner (member) 103 and those assisting in its execution as the supporting Members or partners, e.g. Member 104.

An Opportunity 107 may include the state or period of time during which the managing Member 103 is estimating the overall project requirements, negotiating with possible supporting Members 104 on what each would provide to the overall job/project effort 109.

As part of this process, the effort or opportunity 107 may be broken into specific line items 108 whereby each line may represent a product fulfillment or services task.

Each line item 108 may also be mapped or associated to a single Sponsor 101, although some line items may not. An example would be a line item which covers the purchase of a particular brand of computer servers, in which the brand manufacturer may become the sponsor for the respective line item 108.

Sponsors may allocate Member rewards and incentives 105 as a function of the line items which apply to them, e.g. through the use of a promotion managers and the like.

During the opportunity stage 107, estimated reward amounts may be given by the Sponsor 101 through the system in a Sponsor programmed or manual fashion. For example, a manufacturer may have a predetermined incentive applicable to a designated product that is applicable to opportunity 107, and/or may present targeted incentives to a particular opportunity 107 based on requests or other parameters. Thus, the system may support a broad and flexible mechanism for sponsors to offer incentives to participating members, and also encourage collaboration between participating members that use common rewards such as collaboration currency.

The Overall Job/Project 109 may be registered with each participating Sponsor 101 via a single-step, once a customer 110 commits to moving forward with the opportunity (in part or as a whole). Thus, the overall effort may mature from an opportunity to a registered collaboration 107, including predetermined sponsor-provided incentives 105.

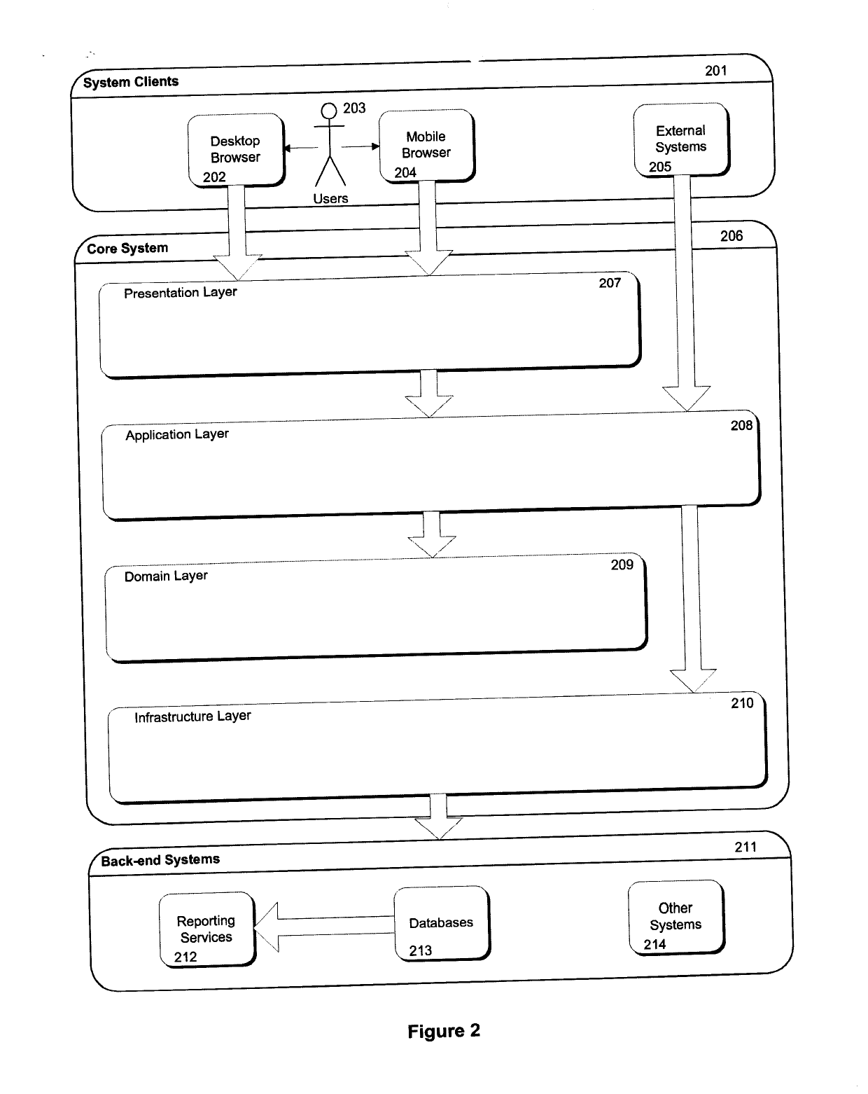

As mentioned above, exemplary systems and methods may be implemented by way of a web-based platform such as shown in FIG. 2. In embodiments, the system may allow Members, such as a user 203, access through system clients 201 including, for example, web and mobile browsers 202, 204, as well as external systems and other clients 205 which may access the platform through a web service based application programming interface (API) 208 or Application Layer. External systems could be line of business systems, sites or programs which Members or Sponsors connect to the platform.

Exemplary core system 206 may be subdivided into layers, or modules configured according to programming instructions running on one or more microprocessors. Each layer/module may be configured to serve a specific purpose, and may, for example, be configured to reside on a single server, or multiple servers such as in a web farm environment. As shown in FIG. 2, exemplary layers/modules may include Presentation Layer 207, Application Layer 208, Domain Layer 209 and Infrastructure Layer 210.

The Presentation Layer 207 may include a web server layer configured for receiving and dispatching instructions from clients as well as presenting views and user interfaces. This layer may be based on a pseudo model-view-controller (MVC) pattern and may be, for example, configured as a client itself of the Application Layer 208. The actual Model resides in a Domain Layer 209.

The Application Layer 208 may include Services which coordinate tasks and delegate work to business objects in the Domain Layer 209. The Application Services may be configured to act as a Remote Facade to business objects and rules which inherently define the system.

A Domain Layer 209 layer may include system logic, containers, objects, structures, factories and rules of the business aspects of the system. Such features provide various functionality to the system, and facilitate and/or make available the business objects, and entities, to the system for processing and handling.

An Infrastructure Layer 210 may be configured to hold elements that are required, for example, as part of modern web platforms. This layer may include, for example, cross cutting concerns such as logging, data I/O, security, integration and others.

Behind the Infrastructure Layer 210, back-end systems 211 may be used to further support the platform. These may include web platform building blocks and include reporting services 212, database servers 213 and other systems 214, processes or methods as required.

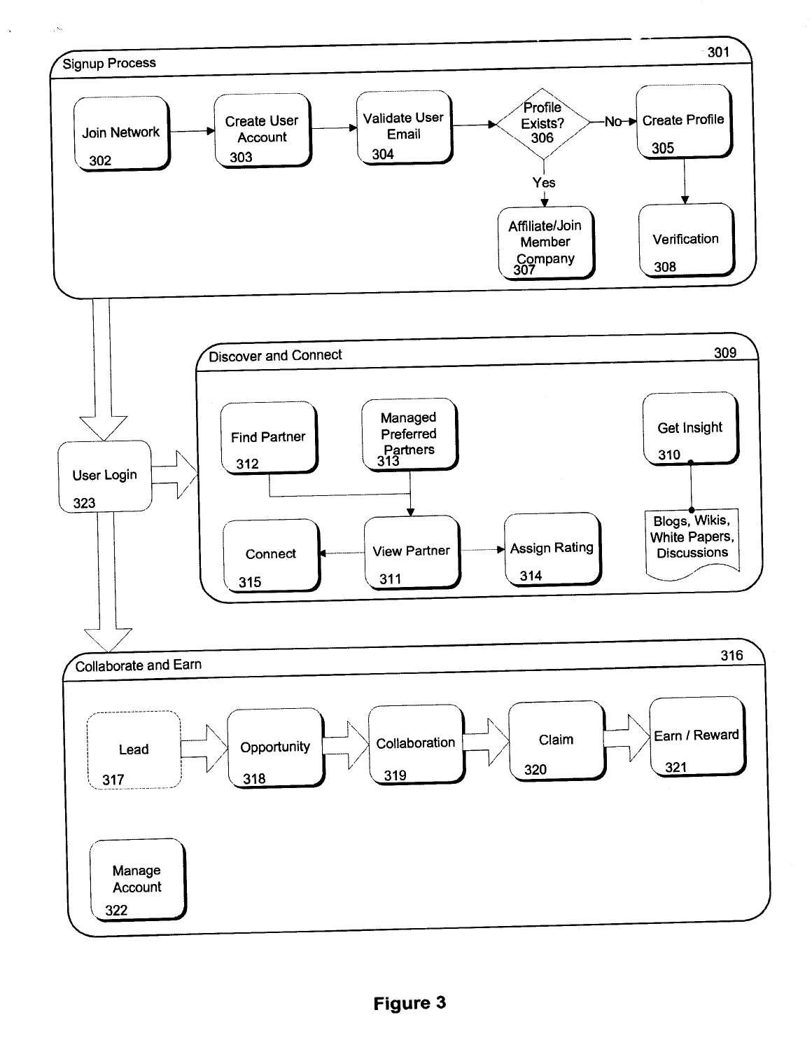

FIG. 3 illustrates aspects of three “lifecycles” or high level processes which may be performed according to systems and methods described herein. A first cycle 301 may be initiated, for example, when a user first joins 302 the network. Once a user is setup and their company is registered as a Member, the user can login and use the Discover and Connect features 309 or proceed to an opportunity or collaboration 316.

The signup process 301 may include a multi-step process whereby after the first step 302 a user may create a user account 303. Based on authentication credentials, which may be provided in 303, a validation process may be initiated to ensure, for example, the use of a valid email address in 304. The method may continue with 306.

In step 306 a determination may be made as to whether a member company profile exists. If a corresponding member company profile exists, the user may be joined to the existing company in step 307, e.g. if the user has an invitation to do so. Otherwise, a new Member company account may be created in step 305, which may also be validated in step 308, such as through the various Sponsors they represent in industry. This validation may be automated, such as by automatically sending confirmation messages, scanning white lists, and the like, or done through a manual process by the Sponsors. Exemplary systems may allow for more than one user to be assigned to a single Member company.

Once users are setup, they may login 323 to the system and can navigate various features, such as those features with permissions assigned to the corresponding Member company or individual user. For example, the user may be provided access to the Discover and Connect section 309, in which users may be given tools to find Partner Members 312, such as by specifying desired attributes they desire Partners to have. These attributes can be, for example, location based and/or driven by Sponsor qualifications and staff certifications. Search 312 can also be refined by the use of keywords and other techniques known in the art. In embodiments, Members can select specific partners to become “Preferred Partners” 313, which may be used, for example, to simplify communications and/or restrict opportunity item routing.

Throughout the system, users may be allowed to get a Member company's profile, such as in by viewing a potential or actual partner in step 311, and may be allowed to connect with the partner by contacting predetermined key contacts in connect step 315.

Ratings may also be assigned, for example by an authorized user, to Members in step 314, which may be used, for example, to measure and report on a Member's effectiveness in collaborating on efforts, the Member's ability to influence business opportunities, and other criteria relevant and/or unique to the collaborative environment.

With further reference to FIG. 3, a registered user may also access a business lifecycle of the system depicted as a Collaborate and Earn process 316. Process 316 shows aspects of an exemplary business flow, highlights of which are discussed below. Leads 317 are typically sourced from vendors or other third party sources. A Lead may or may not precede an Opportunity 318, and may be targeted to specific Members or select group(s) of Members (e.g. preferred partners), or published to the entire network based on screening criteria.

Opportunities 318 are managed by Members (managing partners). They may be created directly in the system, e.g. by authorized users, or by converting a Lead 317. Supporting partners may be solicited and selected to assist/share work. In embodiments, supporting partners must be Members or become Members to qualify for any benefits available through the Network.

Collaborations 319 are registered opportunities 318 that have been toggled by a customer approving the project. Collaborations line items may be individually registered with Sponsors, and Sponsors may authorize reward funding upon the registration, as discussed herein. Claims 320 result from performance of line items according to registered opportunities 318, and may be used to award rewards performed by the managing partner on a line item basis once a work item is completed. A claim 320 with proof of performance may be submitted to the system. Once approved, pre-designated incentives, such as Collaboration Currency, may be issued from vendors and distributed, for example, by the managing partner.

Rewards may be issued and distributed in step 321, and may include, for example, funds expressed in Collaboration Currency. Rewards may be converted to, for example, Cash, Transfers/Shares for supporting Partners, System Subscription dues, and/or Member Services Catalog which may provide options, such as, business-related services from authorized third-party providers to help Members improve their business' performance.

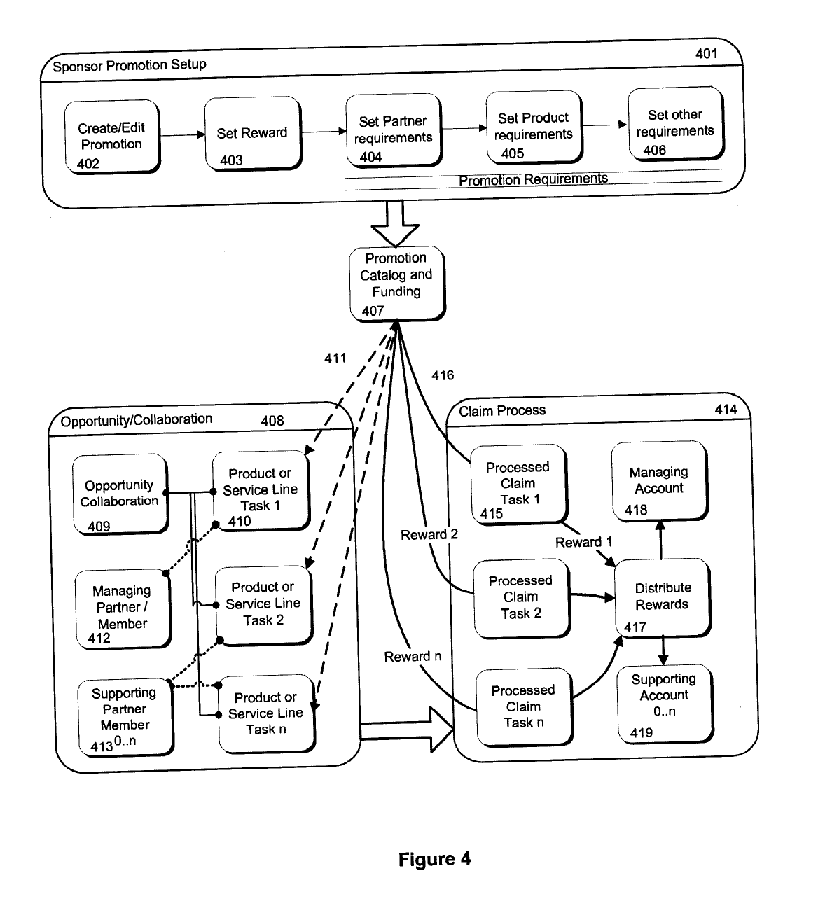

FIG. 4 provides additional details regarding exemplary systems and methods including aspects of an Incentive Accounting program. As shown in FIG. 4, Sponsors may set up their reward promotions 401 and designate how the promotions may relate to opportunities, collaborations 408 and the claim process 414. In order for rewards to be made available to a Member, the system provides Sponsors with tools to create the promotion beginning in step 402, e.g. to set business rules on work items which drive funding types, and to set applicable rewards in step 403, as well as their applicability such as partner related parameters, e.g. partner tier, competency requirements, etc., and product parameters, e.g. types, categories, product requirements, etc., in steps 404 and 405, respectively. Other parameters may be set according to sponsor preferences in step 406, e.g. time limits, etc.

The collection of promotions from multiple Sponsors may be accomplished in step 407 and may be used for a Promotion Catalog which is used by the system to estimate various rewards 411 on work items 410 during the Opportunity and Collaboration phases 408, and to attribute actual rewards 416 upon the submission of actual work item claims 415.

With further reference to FIG. 4, opportunity/collaboration cycle 408 may include assigning line item responsibilities 410 of collaboration 409 to various supporting members 413 by a managing partner 412. For example, as discussed further herein, a managing member may be determined in step 412, and supporting members assigned in step(s) 413. Based on these designations, a collaboration may be created in step 409, including various line item related rewards 411. As line items designated in step(s) 410 are completed, claims may be verified in step(s) 415, and rewards 416 processed to designated supporting accounts 419 via managing account 418. For example, the rewards earned may be distributed in step 417, such as by a managing account approval in step 418, to the other supporting Members in step 419.

As discussed herein, the disclosed systems and methods may provide a PartnerConduit (PCN) that may include a business-to-business (B2B) application enabling independent reseller and influencer organizations (Partners) to aggregate and monetize the benefits of marketing programs from multiple manufacturer/vendor organizations (Vendors) and to redeem, reinvest or reallocate them using a common media, such as Collaboration Currency. Unlike current Partner Relationship Systems (PRM), wherein a Vendor can manage its own proprietary Joint Marketing Fund, Deal/Opportunity Registration and promotional marketing programs in a stand-alone environment, PCN replaces the stand-alone environment with a multi-Vendor approach that enable Partners to tap in to reseller marketing benefits the same way they conduct their B2B customer business, thereby combining the products/services of multiple Vendors and their own resources to provide a unique customer solution.

Unlike the proprietary Partner ecosystems, built on proprietary or PRM technologies, which are maintained by leading Vendors (and desired by smaller Vendors), the PCN encourages and facilitates Partners finding other qualified Partners with whom they can collaborate across industry boundaries. For example, when Partner A can provide most of a unique customer solution using Vendor 1 and Vendor 2 products, but lacks some capability such as domain expertise, industry/vendor recognized certifications, vertical industry experience or geographic coverage to provide a complete solution, through the PCN application they can find Partner B with the verified bench strength and complementary skill sets to complete the specified assignment in the context it is needed. And when Partner B has the certifications and credentials to support the customer requirements for Vendor 3 products, the customer can be assured that they are using authorized, expert solution providers for the entire assignment.

As described above, a Partner Rating system provides PCN members with insight into how effective potential Partners are at working collaboratively, and can provide additional specialized information that is relevant to the particular collaboration project at hand. Current ranking systems and methods do not provide comparable information in a format to facilitate effective collaboration. Additionally, by designing the interface from the Partners' perspective and on-boarding Vendors via a common process, PCN enables Partners to access all the participating Vendors via a single interface rather than having to navigate many different Vendor programs independently, in a resource-intensive process.

Since most Partners have more ‘active’ Vendor relationships (e.g. 20-30) than they typically manage to engage fully with (e.g. 4-6 ‘strategic’ Vendors) based on the way Vendors approach them, the PCN allows them to take more comprehensive advantage of all their ‘active’ relationships, such as by putting them in a profile once and then any time they are using a specific Vendors' eligible products/services in a customer opportunity, the system tracks its value in marketing funds, e.g. Collaboration Currency. This may enable a Partner to more efficiently source and sell multi-Vendor solutions which their customers demand but for which the reporting burden often left Joint Marketing Funds or promotional marketing rewards unclaimed.

The system may create reporting templates, using Vendor pre-authorized business rules that can automate such aspects as the lead distribution, registration, calculation, tracking and validation of all participating Vendor product/services Opportunities. For Vendors, this enables them to participate in a network or coalition of complementary products and services, combining their products and services with the products/services of other Vendors in the system under the management of a professionally certified and authorized Partner, while maintaining control of the business rules impacting their participation and funding of Joint Marketing Funds/promotions.

The application may track Partner-identified collaborations throughout the entire Opportunity lifecycle (Lead-Registered Opportunity-Sold-Delivered-Claimed), and shift control of the currency from Vendor to Partner upon completed proof-of-performance. For each Opportunity there is a Managing/Lead Partner (Partner A) and one or more Participating/Support Partners (Partner B). For example, if Partner A identified and qualified an opportunity with a B2B customer requiring products/services including hardware (Vendor 1), general business software (Vendor 2), and a vertically specialized application software (Vendor 3) and also required Partner B to provide authorized service and support on Vendor 3 products, then the entire transaction may be entered and tracked within the PCN application.

Since Vendor 1 and Vendor 3 are both participating in PCN, the system may automatically track the revenues value and the Collaboration Currency commitment values based on each Vendor's customizable set-up. In this example, Vendor 1 is funding Collaboration Currency (CC$) at a rate of 1.25% of the Revenue Value, while Vendor 3 is funding at a rate of 1%. Vendor 2 is not in the PCN but the full details of the transaction are captured for the convenience of Partner A as the managing Partner.

Partners within the network are encouraged to share or redistribute common currency to contributing Partners that collaborated during the sale/delivery process, reinvest via network authorized service providers through a direct payment process to organizations providing services to promote business growth or offset business expenses, or they may redeem their Collaboration Currency for cash in their local currency. Thus, the disclosed common rewards currency used within the system is readily usable across boundaries, such as those arising from international borders and monetary currencies, in that the currency is fully useable within the system without reference to external exchange value and the like, until the time of redemption.

In the example above Partner A designates that 50% of the 650 in Collaboration Currency is to be shared with Partner B, or it could have designated that all or any percentage of the Collaboration Currency be redistributed to Partner B—at their discretion but in a manner transparent to Partner B using the Share function that is automatically managed within the system.

Various embodiments of the partner system and reward distribution system are described above. Concurrent with the reward system is the inclusion of rebate programs and the calculations of partner incentive programs. While the above system provides for partner integration into the system, incentive programs allow for reward distributions, wherein prior to or concurrent with the execution of an incentive program, the system may determine the effectiveness and/or tracking of the program.

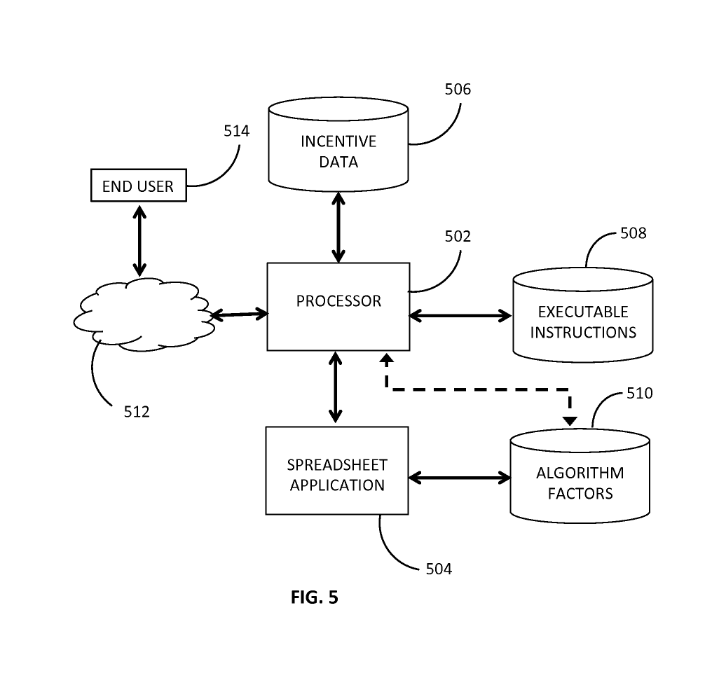

FIG. 5 illustrates one embodiment of a rebate calculation processing system, wherein the rebate calculation relates to the partner incentive program. The system 500 includes a processor 502, a spreadsheet application 504, data storage device 506 having incentive data stored therein, data storage device 508 having executable instructions stored therein, and data storage device 510 storing algorithm factors therein. The system 500 further includes a network connection 512 providing communication and interaction with an end user 514.

In this embodiment, the processor 502 may be one or more processing devices in a unitary or distributed computing environment. The spreadsheet application may be any suitable spreadsheet or columnar processing application providing for columnar integration of data and the execution of one or more scenario or processing algorithms on the columnar data. In one embodiment, the spreadsheet application may be Excel® available from Microsoft Corporation. The application 504 may execute on one or more processing environments, which may be centrally hosted with the processor 502, or may be in a distributed computing environment.

The data storage devices 506, 508 and 510 may be any suitable computer readable medium, including for example non-transitory computer readable medium, wherein data is stored thereon and accessed therefrom. The incentive data includes data relating to the incentive program, including tracks within the program, incentives within the tracks and other data as described in further detail below. The executable instructions include any type of instructions readable by the processor for executing the operational steps as described herein. Algorithm factors include the computational factors and equations executable within the spreadsheet application, as defined either directly by the application 504, or may be defined by the processor 502, such as in response to an end user 514 instructional request.

The network 512 may be the Internet or any other suitable networked environment. The rebate calculation performed by the processor 502 may be executed in a software-as-a-service processing environment allowing for the end user 514 directed access via the network 512, minimizing local processing operations by the end user and dedicating the processing on the processor 502.

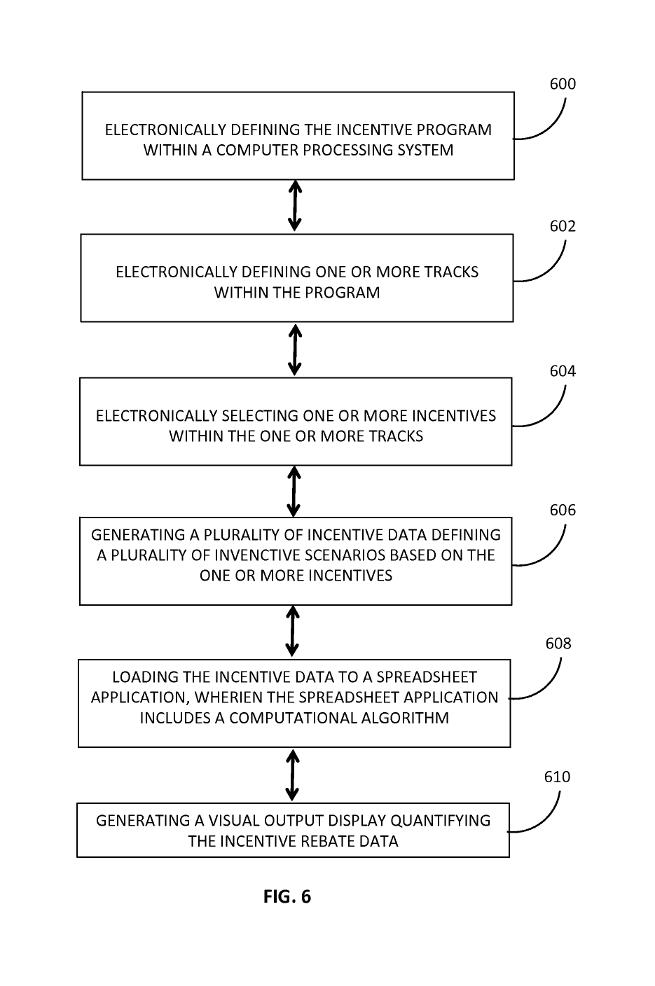

For the sake of brevity, embodiments of the execution of the system 500 are described in the flowchart of FIG. 6. In FIG. 6, a first step, step 600, is electronically defining the incentive program within the computer processing system. The computer processing system includes the process 502 and executable instructions 508. The defining of the incentive program may include, in one embodiment, defining the nature of the program, anticipated partners, participants, rewards, estimated sales objectives, as well as any other data. In one embodiment, there is no business logic at the program level.

A next step, step 602, is electronically defining one or more tracks within the program. The tracks are a subset of the program, in general. The tracks define specific instances of the program, for example different tracks may be different focused markets, different partners, different types of rebate scenarios, etc. The tracks are a sub-class of the program defined in step 600.

A next step, step 604, is the electronic selection of one or more incentives within the one or more tracks. In one embodiment, this electronic selection may include selection via a graphical user interface, including pull-down menus. The incentives may be any suitable type of incentive as defined by the end user, wherein the incentive relates to the program and provides for a rebate or other type of remuneration to indicated partners.

A next step, step 606, is generating a plurality of incentive data defining a plurality of incentive scenarios based on the one or more incentives. As described in further detail below, the processing 502 of FIG. 5 includes a graphical user interface allowing for the end user 514, via the network connection 512, to define the incentive scenarios, including scenarios for providing incentives to various partners, vendors, and other parties.

Step 608 includes loading the incentive data to a spreadsheet application, wherein the spreadsheet application includes a computational algorithm. With respect to FIG. 5, this step includes loading the incentive data generated by the processor 502, as well as may be stored in the data storage device 506, to the spreadsheet application 504. In one embodiment, the application 504 executes on a separate processing platform, but it is also recognized that the application 504 may execute locally with the processor 502.

As described in further detail below, the spreadsheet application is operative to perform various processing operations based on algorithm factors. The operations determine rebate scenarios based on the computational algorithms using the algorithm factors. Therein, the next step is generating a visual output display quantifying the incentive rebate data, step 610. For example, a visual output may include a dashboard or other type of display providing for the display of the incentive program.

The rebate calculation allows the end user 524, which may be a system administrator, to readily create and manage complex calculations on a significantly large number of records by utilizing the algorithmic processing capabilities of a spreadsheet application and the user interactivity of standard query logic SQL. The rebate calculation processing system enables the ability to model and manage concurrent calculations through flexible, user-friendly framework with the processor 502 and the spreadsheet application 504. The user 524 can quickly and easily use a scenario builder, as described in further detail below, to develop rebate scenarios for achieving financial and sales targets, as well as determine the financial impact of a program prior to launching the program. Via the rebate calculation system, the user 524 can model various scenarios for side-by-side comparison, as well as output the results to the spreadsheet application for analysis, as well as manager or third-party approval. Similarly, the user 524 can create and manage multiple rebate structures each with unique targets by partner type, product, geography, and time period, including in additional embodiments creating supplemental or secondary rewards as part of the campaign.

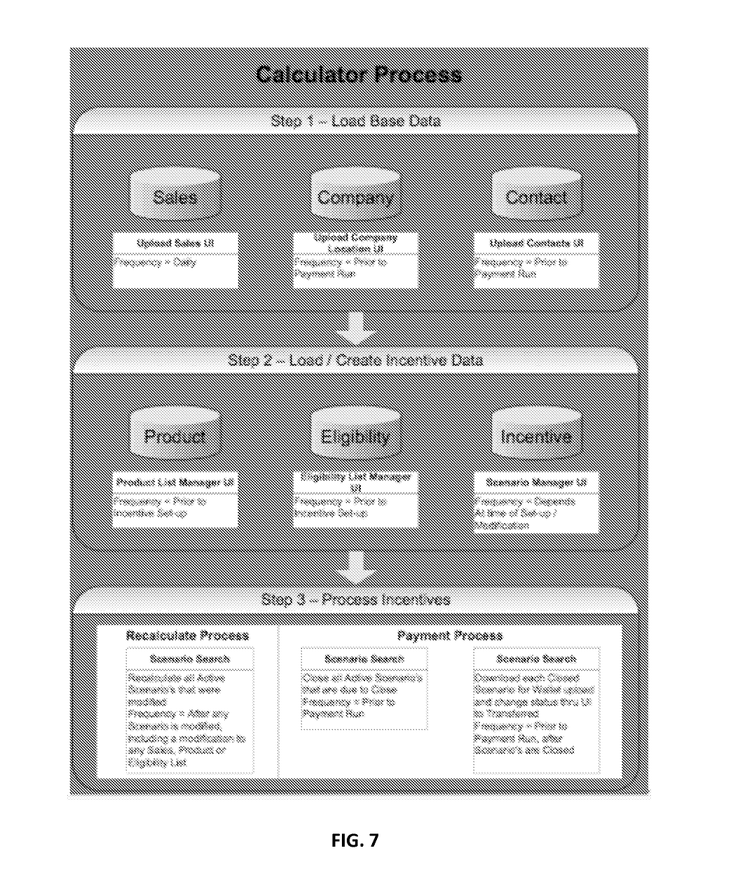

FIG. 7 illustrates a block diagram of one embodiment of the calculator process. The first step is described as the load base data step. The step includes data sales data, company data and contact data. The sales data may be uploaded using the partner system user interface and can be at any set frequency, such as in one embodiment being performed daily. The company information can be uploaded using location user interface and the frequency can be prior to a payment run. The contact information can be loaded into the system using a contacts user interface and similar to the company data, can be done prior to a payment run, wherein the payment run provides rebate calculation and payment to various partners.

In step 2 of the process of FIG. 7, the load/create incentive data process, there are three data categories: product; eligibility; and incentive. The system includes a product list manager user interface including the loading of product information. The eligibility data is provided via an eligibility list manager user interface. The product data and the eligibility data can be provided prior to incentive set-up and the user interface may include user pull-down menus and data entry fields for entering the corresponding information.

Within this load/create incentive data step, a third data field is incentive data, which can be provided by the scenario manager user interface. The incentive data can be generated, entered and/or uploaded as described herein, with frequency being based on user preferences, including at the time of set-up or modified during program execution.

In the calculator process, step 3 is the process incentives. This process includes re-calculation scenarios, as well as the payment process. In the recalculation scenario, a user can perform the recalculation of all active scenarios that were modified. This includes the ability to view the effectiveness and/or modify mid-campaign various incentive programs. Users may seek modification of the incentive program for any number of reasons, including for examples of increased rewards, changing the incentive program focus to include different types of rewards, to focus on different customers or geographic regions or zones, etc. In the processing of incentives, step 3, the user can then recalculate the scenario information.

Additionally in step 3, there is also the processing of incentives, including the payment of incentive to partners. The payment process includes two types of scenario searching, active and closed scenarios. For active scenarios, the user can close scenarios that are about to expire and then run a payment process. For closed scenarios, the processing system may interact with a wallet application or other type of rebate distribution system to include the determination of the pay-out and subsequent distribution of incentives to intended recipients. As described herein, pay-out may include any suitable form of remuneration to the partner, including the payment of actual funds, the transfer of funds to an electronic account, the allocation of credits or discounts to an account, the offsetting of existing monies due or any other form of reward distribution whereby a benefit or reward is provided or attributed to the intended recipients.

As noted above, defining various scenario features and attributes generates the scenario creation. The first defined attribute is the program itself, including a naming attribute for the program. The program, as named, represents the underlying incentive and rebate campaign envisioned by the end user. There is no business logic at the program level.

Within the program, the user then defines one or more tracks. Tracks are defined as sub-sets within the program for allowing for varying incentive programs within the program. For instance, a program may be applicable to partners of varying industries, therefore one embodiment may divide the tracks by industry, for example. Similar to the program level, there is no applicable business logic for scenario calculations or algorithmic processing performed at the track level.

Within the tracks, the user therein defines various incentives. The incentives can be any suitable incentive for the partner, including for example rebates or other financial payments for the performance of various activities. In one example, partners may be granted financial rebates based on the sale of defined number of advertisements, or in another example may be given a percentage of referral sales. It is recognized that the end user 524 of FIG. 5 may select and define any number of incentives, the incentive(s) including financial terms relating to a business or program objective. Business logic at the incentive level includes eligibility factors, such as determining if a partner is eligible for participation within the incentive program. Examples of eligibility type can be company type of the partner and location of the partner, but it is recognized that any other eligibility type may be utilized.

Within the incentives, the user can therein define scenarios. Business logic and algorithmic execution provide for the scenario calculations. The scenarios include not only the business logic performed via the algorithmic operations, but related combinations of the eligibility factors, a products list, a sales period and calculation rules within the spreadsheet application. As noted above, the incentive program relates to one or more business goals, such as the sales of a particular product over a defined time period. Therefore, the scenarios account for these factors.

As noted in FIG. 5, via the processor 502, the user 524 is operative to create and/or modify the scenarios. In one embodiment, the processor 502 includes a scenario manager, which may include a user interface accessible via the network 512. The scenario manager allows a user to create programs, tracks, incentives, and scenarios. For creating the scenario, the user defines all attributes of the program, track, incentive and scenarios as described above, including either user definition or selection of pre-existing programs, tracks, incentives and/or scenarios.

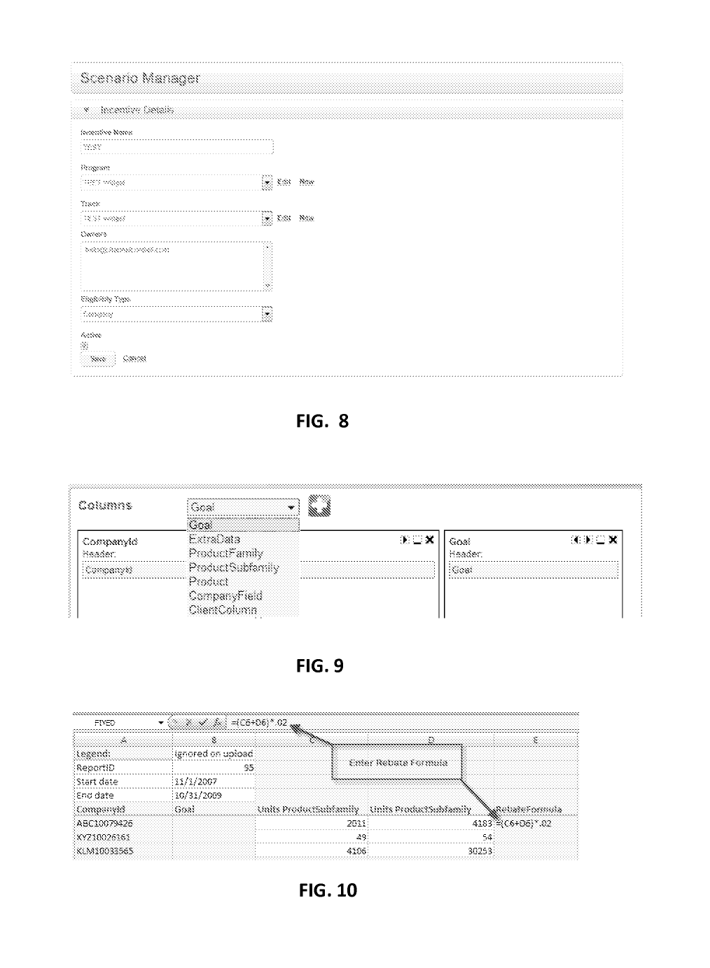

FIG. 8 illustrates an exemplary screenshot of one embodiment of a scenario manager interface. The manager includes a plurality of pull-down menus for the end user to enter the various information, including the incentive name, the program name, the track, owners and eligibility type.

In the example of FIG. 8, name of the incentive provides a title for user interaction and subsequent titling for any report execution. The name of the program may be used for administrative interfacing. The name of the track may be used as search criteria for administrative interfacing, as well as a selector for a benefit summary. The name of the incentive provides for matching with a reward-distribution software component. The owner field provides the contact information, as necessary, for communicating with the partners. The eligibility type can be at the company or location level. An incentive associated with an eligibility list at the company level will pull in all associated location sales. An incentive associated with the eligibility list at the location level will pull in all sales at that specific location.

In the scenario manager, the user additionally defines columns of data to be used in calculations. The scenario manager provides the subsequent data to the spreadsheet application for algorithmic processing, including scenario calculations, therefore the user can define columns of data in anticipation of the spreadsheet processing.

To create scenario columns, embodiments provide for different data entry for different columns fields. One field is a scenario name, this will be visible on any reporting or benefits statement. Another field is an eligibility list grouping, which narrows dropdown choices of the eligibility list. The eligibility list is a selection of the actual fields in the eligibility list. A currency field can define the rebate or reward currency, as well as the corresponding sales/transaction currency for the partner. Start field indicates when the sales period begins. An active field provides a toggle indicator if the rebate program is active or inactive. A number of months field defines the length of the rebate program. A product group list indicates which groups of products are part of the rebate or reward program and a group list indicates specific products. Another exemplary field may be the show in benefit statement field that provides scenarios can be actively calculated but are omitted from the display of results on a progress portion of a benefits statement or summary. It is recognized that other suitable fields may be utilized and the above list is exemplary and not limiting in nature.

FIG. 9 illustrates an example of a screenshot of defining or adding columns to the scenario manager. In this example, the user is presented with a pull down menu offering various additional columns to be added, including goal information, additional data, product information, company information and client information. In the selection of these fields, the user can then enter the additional information including the incentive data for subsequent processing by the scenario manager.

The scenario manager therein provides for the exportation of the scenario data to the spreadsheet application, 504 of FIG. 5. Within the spreadsheet application, in one embodiment, a row of data represents each eligible entity on an associated eligibility list. Moreover, within the spreadsheet application, the user can define various formulas for scenario calculations. The scenarios are calculated using the spreadsheet calculation engine, including algorithm factors 510. The factors 510 may be retrieved by the application 504, or in other embodiments may be provided by the processor 502, such as specifically entered by the end user 514.

Using the columnar format of the spreadsheet application not only utilizes the calculation engine of the application, but also maintains the integrity and formatting of the data itself. In one embodiment, the last column of the spreadsheet application is a rebate formula column including the rebate calculation based on the various other column fields. Therein, the spreadsheet application is operative to perform the scenario calculations based on processing the columnar fields.

In addition to the scenario calculations, the processor 502 provides for the distribution of the scenario information to the end user. The spreadsheet application 504 therein provides for exporting the data back to the processor 502, including uploading the result from the rebate formula column. The processor 502, via a graphical user interface, therein provides a graphical representation of the scenario calculations. Such display may be the display of anticipated results of a campaign, or in another embodiment occurring during a campaign, may be a status or mid-campaign scenario recalculation.

Embodiments provide for different columns, including exemplary columns as described herein. One such example is the extra data type column, where this column can be a placeholder column for additional data. This column can be static data or a formula. Another column is the company type column. This column is used to pull company level information into the calculation, and is static data. The static data is useful for the display on a benefits statement and/or used in calculating a benefit. For example, a company's partner program status can be imported in a company location upload property field and utilized in dynamically determine a rebate percentage in a formula.

Another column can be a client-specific type column. This client column selection is used to pull client specific column types into the calculation. The column type indication is useful for administrative reporting. For example, if a client that a maximum reward cap is a typical data point for a scenario calculation, the user can flag the column as being a maximum cap field and more easily report the information during subsequent processing.

Rebate formula column is another column, this column represents the total calculated rebate for the scenario. The rebate formula column cannot be removed from the scenario. It should also be noted that further modifications and adjustments of columns are envisioned. For example, if a calculation requires more than one sales source then another column may be created for each sales source and the columns combined through a formula, such as a formula placed in the extra field column.

After the creation of the scenario using the columns and processing the scenario data can then be imported into the spreadsheet application. Further user manipulation of the columns may be required, including for example the movement or modifications of various columns of data. The formulas themselves may be required to be filtered down the various rows, dragged down for all the listed companies or locations.

FIG. 10 illustrates a sample screen shot of a spreadsheet application, including the dragging of an equation to the various companies or locations. In the example of FIG. 10, the columns C and D are added together and multiplied by 2 percent, wherein this could have also been accomplished by the inclusion of a 0.02 value in a status data field column.

Therefore, within the spreadsheet application, when the various data columns are defined and the equations are established, the application is operative to perform the processing calculations. In one embodiment, the calculations may be done automatically upon entering data into the fields. In another embodiment, the user may select a run or execute function that then engages the various algorithmic operations. It is recognized that the various columns, algorithm factors and underlying equations may require significant computational resources. Therefore, the operations may be performed locally, offloaded to additional processing resources, timed for execution at non-peak processing times, or other accommodations may be provided.

Upon executing the spreadsheet algorithms of the columnar data, the processor 502 therein extracts the calculated scenario data. The spreadsheet provides, in addition to data management, the processing engine for executing the scenarios. The scenario data is uploaded from the application 504, wherein the processor 502 provides a dashboard or other type of graphical user interface to quantify the incentive rebate data in a visual display.

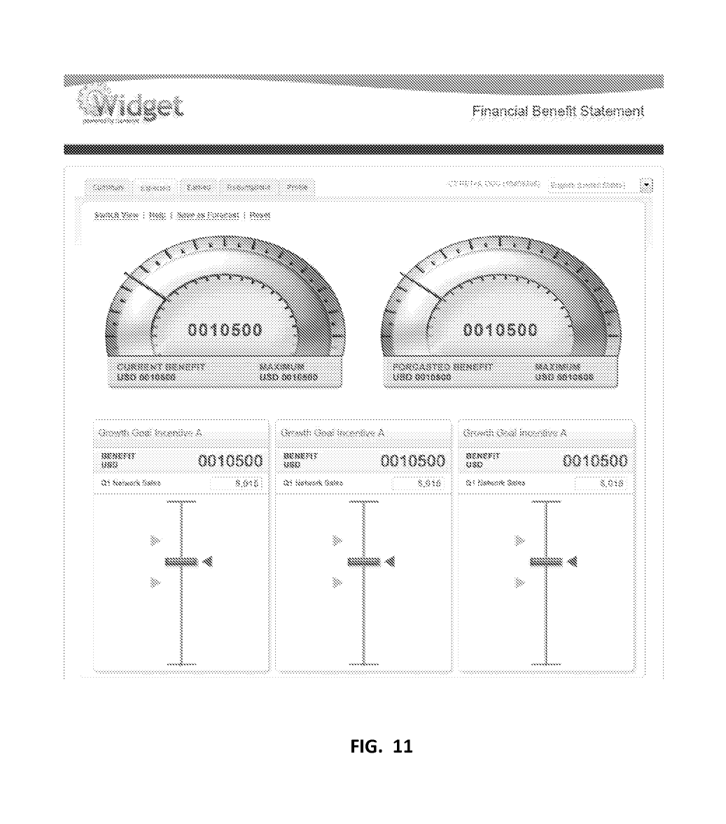

FIG. 11 provides a graphical representation of one exemplary screenshot of a dashboard display. A rebate calculation relating to a partner incentive program is processed via the spreadsheet application and the data translated to illustrate the benefits and projected goals of the program.

Therein, the above described rebate calculation engine compliments the partner reward system of FIGS. 1-4. In addition to generate partner rewards, the rebate calculation engine therein provides a means for reviewing and tracking incentive programs. The rebate engine provides means for previewing or estimating rebate calculation programs, as well as managing or executing selected programs. The various columnar-fields allow for multi-party programs with varying incentives and the integration of the data into a spreadsheet application utilizes and enhances existing computational power and data management techniques.

FIGS. 1 through 11 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for rebate calculation relating to a partner incentive program, the method comprising:
electronically defining the incentive program within a computer processing system;
electronically defining one or more tracks within the program;
electronically selecting one or more incentives within the one or more tracks;
generating a plurality of incentive data defining a plurality of incentive scenarios based on the one or more incentives;
loading the incentive data to a spreadsheet application, wherein the spreadsheet application includes a computational algorithm;
performing at least one scenario calculation on the incentive data using the computational algorithm, including generating incentive rebate data; and
generating a visual output display quantifying the incentive rebate data.

2. The method of claim 1 further comprising:
defining a plurality of algorithm factors for the incentive scenarios, wherein the algorithm factors include one or more columns within the spreadsheet application.

3. The method of claim 2 further comprising:
including additional algorithm factors via inclusion of additional columns within the spreadsheet application.

4. The method of claim 1, wherein the visual output display includes a dashboard illustrating a visual representation of the incentive program.

5. The method of claim 4, wherein the dashboard illustrates the incentive program concurrent with the execution of the incentive program.

6. The method of claim 1 further comprising:
defining a plurality of tracks within the program;
defining a plurality of partners within each of the tracks; and
generating incentive rebate data for each of the partners within the plurality of tracks.

7. The method of claim 1 further comprising:
communicating the incentive rebate data with a product reward system.

8. The method of claim 1 further comprising:
communicating with an eligibility manager computing system; and
determining one or more partners for the incentive program based on at least one of: the track within the program, the incentive data, and the incentive rebate data.

9. The method of claim 1 wherein the rebate calculation provides for generating a rebate as part of the incentive program for a target object, the target object including at least one of: a partner type, a product, a geographical region, and a time period.

10. An apparatus for rebate calculation relating to a partner incentive program, the apparatus comprising:
a computer readable medium having executable instructions stored thereon; and
a processing device, in response to the executable instructions, operative to:
define the incentive program within a computer processing system;
define one or more tracks within the program;
select one or more incentives within the one or more tracks;
generate a plurality of incentive data defining a plurality of incentive scenarios based on the one or more incentives;
load the incentive data to a spreadsheet application, wherein the spreadsheet application includes a computational algorithm;
perform at least one scenario calculation on the incentive data using the computational algorithm, including generating incentive rebate data; and
generate a visual output display quantifying the incentive rebate data.

11. The apparatus of claim 10, the processing device, in response to further executable instructions, further operative to:
define a plurality of algorithm factors for the incentive scenarios, wherein the algorithm factors include one or more columns within the spreadsheet application.

12. The apparatus of claim 11, the processing device, in response to further executable instructions, further operative to:
include additional algorithm factors via inclusion of additional columns within the spreadsheet application.

13. The apparatus of claim 10, wherein the visual output display includes a dashboard illustrating a visual representation of the incentive program.

14. The apparatus of claim 13, wherein the dashboard illustrates the incentive program concurrent with the execution of the incentive program.

15. The apparatus of claim 10, the processing device, in response to further executable instructions, further operative to:
define a plurality of tracks within the program;
define a plurality of partners within each of the tracks; and
generate incentive rebate data for each of the partners within the plurality of tracks.

16. The apparatus of claim 10, the processing device, in response to further executable instructions, further operative to:
communicate the incentive rebate data with a product reward system.

17. The apparatus of claim 10, the processing device, in response to further executable instructions, further operative to:
communicate with an eligibility manager computing system; and
determine one or more partners for the incentive program based on at least one of: the track within the program, the incentive data, and the incentive rebate data.

18. The apparatus of claim 10 wherein the rebate calculation provides for generating a rebate as part of the incentive program for a target object, the target object including at least one of: a partner type, a product, a geographical region, and a time period.
